(19) United States
(12) Patent Application Publication
(10) Pub. No.: US 2023/0343573 A1
(43) Pub. Date: Oct. 26, 2023

(54) MASS SPECTROMETER

(71) Applicant: SHIMADZU CORPORATION, Kyoto-shi, Kyoto (JP)

(72) Inventors: Tatsuki OKUBO, Kyoto-shi (JP); Mamoru HONDA, Kyoto-shi (JP); Yuko OHASHI, Kyoto-shi (JP)

(73) Assignee: SHIMADZU CORPORATION, Kyoto-shi, Kyoto (JP)

(21) Appl. No.: 18/007,322

(22) PCT Filed: Mar. 18, 2021
(86) PCT No.: PCT/JP2021/011197

§ 371 Date: Jan. 30, 2023

(30) Foreign Application Priority Data
Sep. 2, 2020 (JP) 2020-147329

(51) Int. Cl. H01J 49/16; G01N 35/00

(52) U.S. Cl. CPC H01J 49/164; G01N 35/00613

(57) ABSTRACT

A mass spectrometer includes: a measurement unit to perform mass spectrometry on each of a plurality of target samples and a plurality of quality control samples in a predetermined order; a sample information storage unit which stores discrimination information capable of discriminating between the target sample and the quality control sample in a series of measurements of the target samples and the quality control samples; and a display processor to separate a measurement result for the target sample and/or an analysis result derived from the measurement result, and a measurement result for the quality control sample and/or an analysis result derived from the measurement result to create display information in a predetermined format, and display the two pieces of display information on a screen of a display unit by using the discrimination information.

### TECHNICAL FIELD

The present invention relates to a mass spectrometer, and more particularly to a mass spectrometer that automatically and sequentially analyzes a large number of samples and displays the analysis results based on data acquired by the analyses.

### BACKGROUND ART

When analysis is performed by a mass spectrometer equipped with an ion source by a matrix-assisted laser desorption/ionization (MALDI) method, generally, a matrix as an ionization auxiliary is added to a substance to be analyzed, a small amount of the mixed liquid is dropped into a well of a sample plate, and air-dried to form a sample for analysis. In the MALDI mass spectrometer, the sample on the sample plate formed in this way is irradiated with laser light to ionize compounds in the sample, and mass spectrometry is performed on the generated ions.

In recent years, with the rapid progress of mass spectrometry technology, the movement of applying mass spectrometry to clinical examinations and diagnoses of various diseases is progressing. In the application to clinical examination and diagnosis, it is required to measure a large number of specimens collected from a subject or subjects in a hospital, a research institution, and the like as efficiently and quickly as possible. In the MALDI mass spectrometer, a large number of samples previously arranged on one sample plate can be efficiently measured in order. Therefore, the MALDI mass spectrometry method can be said to be a suitable method for the application as described above.

In measurements in the above-described field, it is especially important to ensure measurement quality. Therefore, for example, a quality control (QC) sample for quality evaluation is measured every time a predetermined number of samples derived from a specimen to be examined (hereinafter referred to as “specimen sample”) are measured or before the start of measurements and after the end of measurements of a plurality of specimen samples, to confirm the reliability of data acquired for the specimen sample on the basis of the analysis result of the QC sample (refer to Patent Literature 1 or the like).

### CITATION LIST

### Patent Literature

Patent Literature 1: JP 2018-169377 A
Patent Literature 2: JP 6410810 B2
Patent Literature 3: JP 2019-53063 A

### Non Patent Literature

Non Patent Literature 1: “Novel plasma biomarker surrogating cerebral amyloid deposition” in Proceedings of the Japan Academy Series B Physical and Biological Sciences by N. Kaneko and 12 others, 2014, Vol. 90 (9), pp. 353-364.

### SUMMARY OF INVENTION

### Technical Problem

In the measurements by the MALDI mass spectrometer, the QC sample is formed on a well of a sample plate in the same manner as the specimen sample, and is measured under the same conditions and the same procedure as the specimen sample. Which sample on the well of the large number of wells on the sample plate is the QC sample is determined or set in advance, and the table of the analysis results indicates whether the sample is the specimen sample or the QC sample.

Therefore, an operator determines whether measurements of specimen samples are appropriate while confirming analysis results of QC samples in the table of the analysis result displayed on a screen of a display unit or printed on paper. However, in such a case, there is a problem in that the operator easily confuses the analysis results of the specimen samples and the analysis results of the QC samples, and it is also difficult to grasp the analysis results of which QC samples can be used for evaluation of the analysis results of which specimen samples.

The present invention is made to solve the problem, and an object of the present invention is to provide a mass spectrometer capable of distinguishing between the specimen sample and the QC sample easily, and grasping a correspondence relationship between the analysis result of the specimen sample and the analysis result of the QC sample easily and accurately when the operator (user) confirms the analysis result.

### Solution to Problem

One mode of a mass spectrometer according to the present invention made to solve the above problem is a mass spectrometer including:
a measurement unit configured to perform mass spectrometry on each of a plurality of target samples and a plurality of quality control samples in a predetermined order;
a sample information storage unit which stores discrimination information capable of discriminating between the target sample and the quality control sample in a series of measurements of the target samples and the quality control samples; and
a display processor configured to separate a measurement result for the target sample and/or an analysis result derived from the measurement result, and a measurement result for the quality control sample and/or an analysis result derived from the measurement result to create display information in a predetermined format respectively, and display the two pieces of display information on a screen of a display unit by using the discrimination information stored in the sample information storage unit.

Herein, the “measurement result” is information acquired by mass spectrometry by the measurement unit such as mass spectrum data, and the “analysis result derived from the measurement result” is information acquired by performing predetermined arithmetic processing or analysis processing on the mass spectrum data or the like such as a quantitative value or an index value.

### Advantageous Effects of Invention

In the mass spectrometer according to the above mode of the present invention, for example, every time mass spectrometry measurements are performed by the measurement unit on a predetermined number of target samples (the specimen samples), a mass spectrometry measurement is performed by the measurement unit on a quality control sample. When viewed in time series, the mass spectrometry in the measurement unit is continuously performed regardless of whether the measurement target is a target sample or a quality control sample, but the measurement results and the analysis results for the target samples and the measurement results and the analysis results for the quality control samples are discriminatively displayed on the screen of the display unit. Specifically, for example, the measurement results and the analysis results for the target samples and the measurement results and the analysis results for the quality control samples are listed in separate tables.

With the mass spectrometer of the above mode of the present invention, confusion between the measurement results and the analysis results of the quality control samples and the measurement results and the analysis results of the specimen samples are unlikely to occur. Therefore, the operator can appropriately and efficiently evaluate the reliability of the measurement result and the analysis result of the specimen sample using the measurement result and the analysis result of the quality control sample.

### BRIEF DESCRIPTION OF DRAWINGS

FIG. 1 is a schematic configuration diagram of a MALDI mass spectrometer according to an embodiment of the present invention.

FIG. 2 is a schematic diagram illustrating a sample measurement order by the MALDI mass spectrometer according to the present embodiment.

FIG. 3 is a schematic diagram illustrating a relationship between samples formed in each well on a sample plate and a measurement order of the samples in the MALDI mass spectrometer in the present embodiment.

FIG. 4 is a diagram illustrating a display example of an analysis result in the MALDI mass spectrometer in the present embodiment.

FIG. 5 is a diagram illustrating another display example of the analysis result in the MALDI mass spectrometer in the present embodiment.

FIG. 6 is a diagram illustrating the display example of the analysis result for each sample in the MALDI mass spectrometer in the present embodiment.

### DESCRIPTION OF EMBODIMENTS

Hereinafter, one embodiment of a MALDI mass spectrometer according to the present invention will be described with reference to the accompanying drawings.

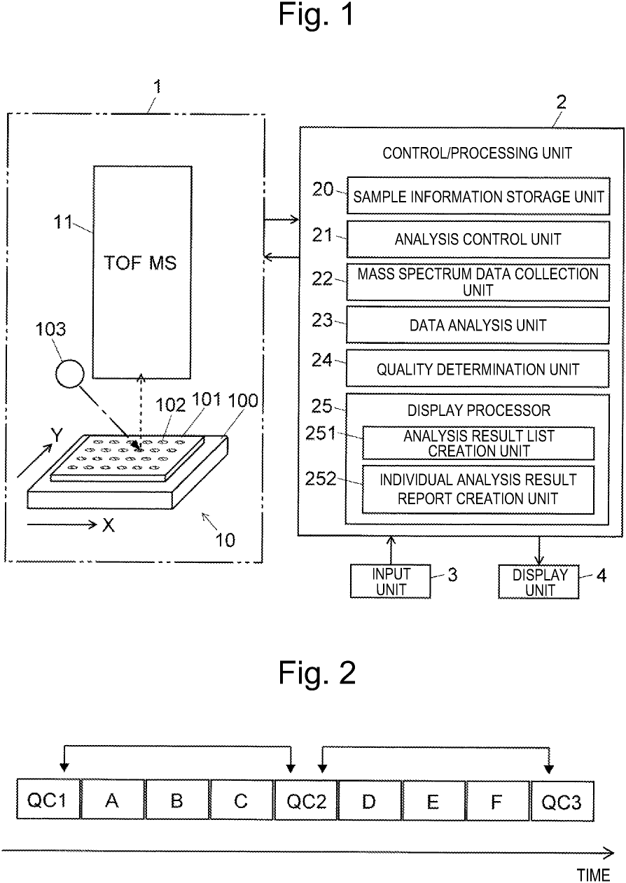

FIG. 1 is a schematic configuration diagram of the MALDI mass spectrometer in the present embodiment.

The MALDI mass spectrometer includes a measurement unit 1, a control/processing unit 2, an input unit 3, and a display unit 4. The measurement unit 1 includes a MALDI ion source 10 and a time-of-flight mass spectrometry unit (TOF MS). The MALDI ion source 10 includes a stage 100 that holds a sample plate 101, and a laser irradiation unit 103 that irradiates a sample 102 on the sample plate 101 with a laser beam for ionization. The stage 100 is movable in two axial directions of an X axis and a Y axis orthogonal to each other by a stage driving mechanism which is not illustrated.

The control/processing unit 2 includes, as functional blocks, a sample information storage unit 20, an analysis control unit 21, a mass spectrum data collection unit 22, a data analysis unit 23, a quality determination unit 24, and a display processor 25 including an analysis result list creation unit 251 and an individual analysis result report creation unit 252.

The control/processing unit 2 is mainly composed of a personal computer or a computer with higher performance than the personal computer, and functions of functional blocks as described later can be realized by operating dedicated control and processing software installed in advance in the computer on the computer.

Herein, the operation of the MALDI mass spectrometer of the present embodiment will be described by taking as an example a case where a biological sample such as blood collected from a subject is used as a specimen, and the degree of progression of Alzheimer’s disease is examined by examining amyloid β (Amyloid β) in the specimen. This inspection method is a known inspection method disclosed in Patent Literatures 2 and 3, Non Patent Literature 1, and the like, and is a method of determining the presence or absence of accumulation of amyloid β in the brain on the basis of the intensity ratio of a plurality of peaks having a specific mass-to-charge ratio (m/z) derived from a peptide related to amyloid β observed in a mass spectrum acquired by performing mass spectrometry on a biological sample.

First, as a sample preparation step, a predetermined matrix for MALDI is added to a specimen prepared from blood or the like collected from a subject (that is, various pretreatments are performed), and a mixed liquid is dropped into a well on the sample plate 101. In addition, the same matrix is also added to the quality control substance, and the mixed liquid is dropped into another well on the sample plate 101. The liquid dropped into each well of the sample plate 101 is air-dried to form the sample 102. The sample derived from the specimen is a specimen sample, and the sample derived from the quality control substance is a QC sample.

Generally, in this type of MALDI mass spectrometry method, the measurement of QC samples is performed before and after a series of measurements is performed on a predetermined number (n) of specimen samples, and the number of n is determined in advance. Therefore, it is common to determine a position of the well for forming the QC sample on the sample plate 101 in advance, and the operator forms the specimen sample and the QC sample according to the rule. Herein, as an example, n = 3.

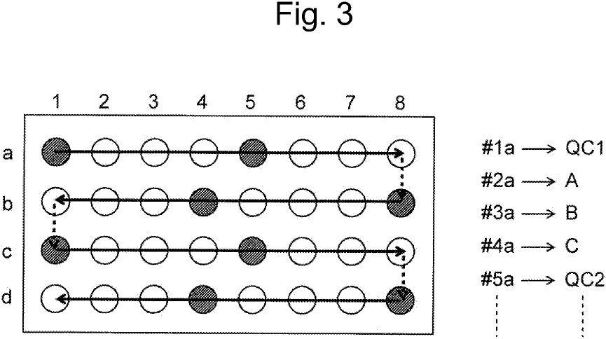

FIG. 2 is a schematic diagram illustrating an example of a sample measurement order. In addition, FIG. 3 is a schematic diagram illustrating a relationship between samples formed in each well on the sample plate 101 and a measurement order of the samples.

FIG. 3 is a top plan view of the sample plate 101, and in this example, the wells are arranged in four rows and eight columns. Each row is identified by an alphanumeric character; a, b, ..., and each column is identified by a number; 1, 2, .... Each well is assigned an identifier combining the alphanumeric character and the number, such as 1a, 2a, .... The measurement order in the MALDI mass spectrometer is determined as indicated by a thick arrow in FIG. 3, and when the measurement order is indicated by the identifier of the well, the measurement order is 1a → 2a →...→ 8a → 8b → 7b →.... Therefore, as illustrated on the right side of FIG. 3, when the QC samples (sample IDs are “QC1”, “QC2”, “QC3”, ...) are formed in wells #1a, #5a, #8b, ..., respectively, and an actual specimen sample with the sample ID “A” is formed in the well #2a, an actual specimen sample with the sample ID “B” is formed in the well #3a, and an actual specimen sample with the sample ID “C” is formed in the well # 4a, ..., respectively, the measurement of each sample can be performed in the order illustrated in FIG. 2.

As described above, if n is determined in advance and the measurement order for the sample on the sample plate 101 is also determined in advance as illustrated in FIG. 3, information on which well on the sample plate 101 have the QC sample, that is, the identifier of the well in which the QC sample is present is determined. Information for identifying the type of each sample on the sample plate 101 is stored in advance in the sample information storage unit 20.

In addition, the operator can appropriately determine the position of the well for forming the QC sample on the sample plate 101. In this case, before performing a series of measurements on the sample plate 101, the operator inputs the position (identifier) of the well in which the QC sample is present using the input unit 3. Upon receiving the input, the control/processing unit 2 stores the input information in the sample information storage unit 20 as discrimination information for discriminating between the QC sample and the actual specimen sample.

The operator sets the sample plate 101 on which the specimen sample and the QC sample are formed as described above on the stage 100, and instructs the start of measurement using the input unit 3. Upon receiving this instruction, the analysis control unit 21 controls the measurement unit 1 to perform measurement on each sample 102 on the sample plate 101 in a predetermined order.

Under the control of the analysis control unit 21, in the measurement unit 1, the stage 100 is moved so that predetermined samples on the sample plate 101 sequentially come to the irradiation position of the laser beam (that is, a mass spectrometry position). Herein, as illustrated in FIG. 3, the stage 100 is moved so that the sample 102 with sample ID “QC1” → “A” → “B” → “C” → “QC2” → “D” → “E” → “F” → “QC3” →... comes to the mass spectrometry position in order.

The laser irradiation unit 103 irradiates the sample 102 with the laser beam in a pulsed manner every time the sample 102 coming to the mass spectrometry position is replaced, and generates ions derived from the compound contained in the sample 102. The generated ions are introduced into a time-of-flight mass spectrometry unit 11, and each ion is separated and detected according to the mass-to-charge ratio. The detection signal is transmitted to the control/processing unit 2. The mass spectrum data collection unit 22 digitizes the detection signal, converts the detection signal into mass spectrum data, and stores the mass spectrum data. Usually, one sample 102 is repeatedly subjected to a plurality of times of measurement, and data over a predetermined mass-to-charge ratio range obtained in each of the plurality of times of measurement is integrated, so that mass spectrum data for the one sample is acquired. The measurement method itself is exactly the same for both the QC sample and the specimen sample.

Every time mass spectrum data for one sample is acquired, the data analysis unit 23 obtains peak intensities of a plurality of specific mass-to-charge ratios related to amyloid β in the mass spectrum. Then, the index value is calculated by performing predetermined calculation based on the ratio of the peak intensities. Herein, two different index values are calculated from a combination of peak intensities at different mass-to-charge ratios. The data analysis unit 23 calculates the index value for amyloid β determination in the same procedure regardless of whether the measured sample is the specimen sample or the QC sample.

In addition, when the measured sample is confirmed to be the QC sample based on the discrimination information stored in the sample information storage unit 20, the quality determination unit 24 compares the index value acquired by the data analysis unit 23 with a predetermined reference value, and determines that it is pass when the index value is equal to or more than the reference value and that it is reject when the index value is less than the reference value.

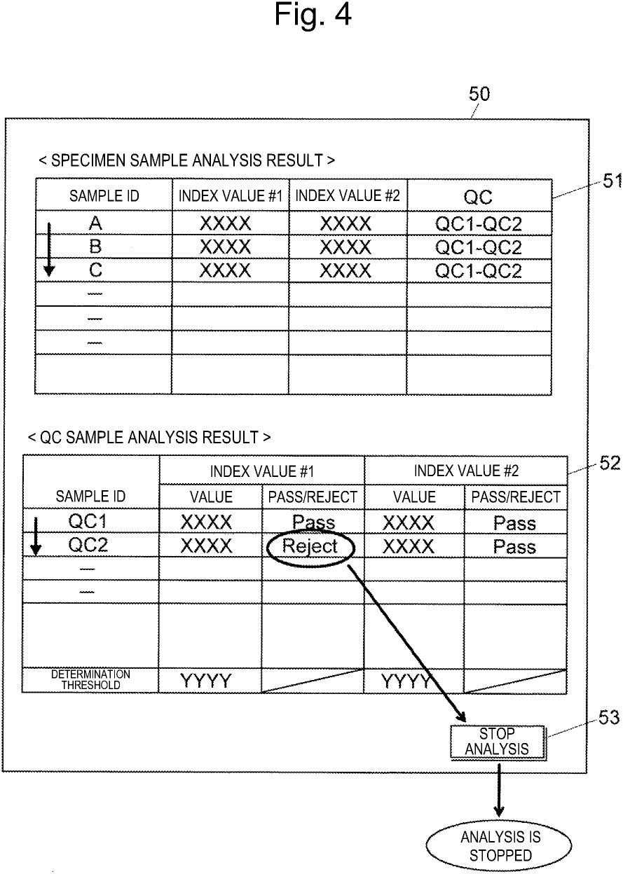

In the display processor 25, when the index value is calculated by the data analysis unit 23 and a quality determination result based on the index value is acquired by the quality determination unit 24, the analysis result list creation unit 251 adds the respective analysis results to different analysis result tables for the specimen sample and the QC sample. Then, the analysis result list creation unit 251 creates an analysis result display screen 50 in which the two analysis result tables are arranged in the same window, and displays the screen on the display unit 4. FIG. 4 is a diagram illustrating an example of the analysis result display screen 50.

On the analysis result display screen 50 illustrated in FIG. 4, a specimen sample analysis result table 51 and a QC sample analysis result table 52 are arranged vertically.

Each row of the specimen sample analysis result table 51 corresponds to an analysis result for one specimen sample, and one row includes the calculation results of two index values #1 and #2 and information of the corresponding QC sample. “QC1-QC2” in the drawing is two QC samples with the sample ID “QC1” and the sample ID “QC2”, the two QC samples being samples for evaluating the reliability of the analysis result of the specimen sample in that row.

Each row of the QC sample analysis result table 52 corresponds to an analysis result for one QC sample, and one row includes the calculation results of two index values #1 and #2 and quality determination results for the index values #1 and #2. In addition, the lowest row of the QC sample analysis result table 52 indicates a determination threshold serving as a reference when the quality determination of the two index values #1 and #2 is performed.

In the conventional device, the analysis result of the specimen sample and the analysis result of the QC sample are generally listed in the same table. On the other hand, in the mass spectrometer of the present embodiment, the analysis result of the specimen sample and the analysis result of the QC sample are sorted and listed in separate tables 51 and 52 based on the discrimination information stored in the sample information storage unit 20.The information in each of the tables 51 and 52 is sequentially added every time the measurement progresses and an analysis result for a new sample is acquired.

As described above, the QC sample analysis result table 52 illustrates the quality determination result of the index value. In the example illustrated in FIG. 4, the analysis results of the three specimen samples with sample IDs “A”, “B”, and “C” are reliable when the analysis results of the two QC samples with sample IDs “QC1” and “QC2” are pass. On the other hand, when the analysis result of any one of the two QC samples with sample IDs “QC1” and “QC2” is reject, the analysis results of the three specimen samples with sample IDs “A”, “B”, and “C” lack reliability. In this example, one index value calculated for the QC sample with the sample ID “QC2” is reject, and the analysis results of the three specimen samples with the sample IDs “A”, “B”, and “C” lack reliability. When such a result is acquired, there is a possibility that there is a defect in the measurement unit 1 itself or there is a problem in sample preparation, setting of measurement conditions, and the like.

Therefore, for example, the operator clicks an “stop analysis” button 53 arranged at the lower right of the analysis result display screen 50 using the input unit 3 when confirming that the analysis result for the QC sample on the analysis result display screen 50 is reject. Then, the analysis control unit 21 that has received this instruction controls the measurement unit 1 to stop the measurement at that time. With this operation, an execution of a subsequent measurement that may be wasted can be stopped. Note that the measurement may be automatically stopped when the analysis result for the QC sample is reject without any operation by the operator.

As described above, with the MALDI mass spectrometer of the present embodiment, the analysis result of the specimen sample and the analysis result of the QC sample are clearly displayed separately, and the relationship between the specimen sample and the QC sample for evaluating the analysis result is also clearly described. Therefore, the operator can easily, accurately, and efficiently confirm the reliability of the analysis result of the specimen sample. In addition, when a defect or the like of the device is suspected from the analysis result of the QC sample, the measurement can be promptly stopped and waste of time and labor can be avoided.

In addition, when the operator gives a predetermined instruction using the input unit 3, the individual analysis result report creation unit 252 extracts only the analysis result of the instructed specific specimen sample, creates a measurement result report including the result, and displays the measurement result report on the display unit 4. Although it is also possible to instruct to display the analysis results for the specimen samples, even in that case, the measurement result report is individually created and displayed for each specimen sample.

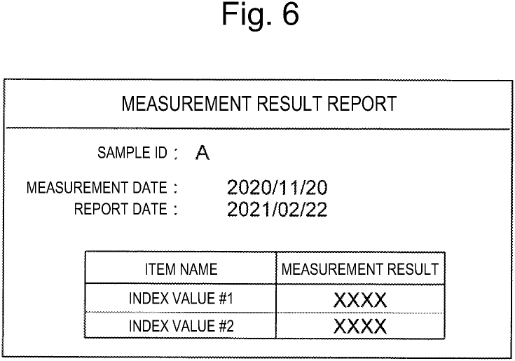

FIG. 6 is a display example of the measurement result report for the actual specimen sample with the sample ID “A”. For example, in a case where the display is as illustrated in FIG. 4, when a person in charge of inspection, a doctor, and the like needs to show an inspection result to the subject, the inspection results of other subjects are also shown at the same time. On the other hand, by performing the display as illustrated in FIG. 6, it is possible to show the inspection result of only the target subject, and it is possible to appropriately protect the personal information. In addition, when the doctor or the like wants to confirm an inspection result of a certain subject, it is also effective to prevent a mistake for an inspection result of another subject.

In the mass spectrometer of the above embodiment, the quality is determined by comparing the index value which is the analysis result of the QC sample with the reference value, but a quality criterion may be changed. For example, when the analysis result of a certain QC sample is extremely deviated from the average value of the analysis results of the QC samples provided in the entire one sample plate, it may be determined that the analysis result of the QC sample is reject.

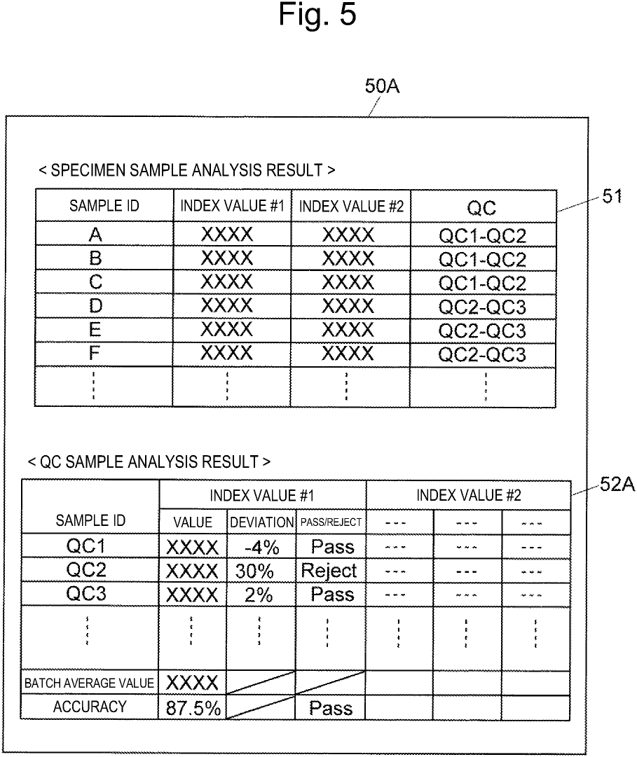

FIG. 5 is an example of an analysis result display screen 50A in that case. In this example, in a QC sample analysis result table 52A, a batch average value is an average value of the analysis results of the QC samples provided in the entire one sample plate, and a deviation is a difference with respect to the average value. A reference value is provided for this deviation, and when the deviation exceeds the reference value, it is determined that the analysis result is reject. In this case, the quality determination cannot be performed until the measurement on the QC samples provided on the entire one sample plate is completed and the analysis result is acquired. Therefore, even though the measurement cannot be stopped in the middle of the measurement like the device of the above embodiment, there is an advantage that the quality determination of the analysis result can be performed precisely while reflecting the variation in the analysis result.

In addition, the mass spectrometer of the above embodiment is the mass spectrometer equipped with the MALDI ion source, but the present invention can also be applied to a mass spectrometer equipped with an ion source by another ionization method. However, the present invention is particularly effective when the measurement is sequentially performed on a large number of samples and the number of QC samples is also relatively large. Thus, the present invention is particularly suitable for the mass spectrometer capable of sequentially measuring a large number of samples prepared in advance and acquiring the analysis result in a short time.

In addition, the above embodiments and modifications are merely examples of the present invention, and it is a matter of course that modifications, corrections, additions, and the like appropriately made within the scope of the gist of the present invention are included in the claims of the present application.

### Various Modes

It will be understood by those skilled in the art that the exemplary embodiments described above are specific examples of the following modes.

(Clause 1) One mode of a mass spectrometer according to the present invention is a mass spectrometer including:
a measurement unit configured to perform mass spectrometry on each of a plurality of target samples and a plurality of quality control samples in a predetermined order;
a sample information storage unit which stores discrimination information capable of discriminating between the target sample and the quality control sample in a series of measurements of the target samples and the quality control samples; and
a display processor configured to separate a measurement result for the target sample and/or an analysis result derived from the measurement result, and a measurement result for the quality control sample and/or an analysis result derived from the measurement result to create display information in a predetermined format respectively, and display the two pieces of display information on a screen of a display unit by using the discrimination information stored in the sample information storage unit.

Specifically, the “separated” “display information in a predetermined format” may be, for example, a separate table in which the measurement results and analysis results are listed.

With the mass spectrometer according to clause 1, the operator can easily confirm the measurement result and the analysis result of the quality control sample, and it may also reduce misrecognition of the measurement result and the analysis result of the target samples. As a result, for example, the evaluation of the validity of the measurement result and the analysis result of the target samples derived from the specimen to be inspected can be performed accurately and efficiently.

(Clause 2) In the mass spectrometer according to clause 1, the measurement unit may be configured to perform matrix-assisted laser desorption/ionization mass spectrometry.

In a MALDI mass spectrometer, generally, the measurement is sequentially performed on a large number of samples prepared in advance in a relatively short time. With the mass spectrometer according to clause 2, even in a case where the number of target samples to be measured is large, confusion between the measurement result and the analysis result of the target sample and the measurement result and the analysis result of the quality control sample is unlikely to occur. Therefore, the validity of the measurement results and the analysis results of the large number of target samples can be evaluated accurately and efficiently.

(Clause 3) In the mass spectrometer according to clause 1 or 2, the display information may include information indicating a relationship between a quality control sample and a target sample for which quality of the measurement result and the analysis result is evaluated using the sample.

With the mass spectrometer according to clause 3, a correspondence relationship between a certain target sample and a quality control sample used for evaluating the reliability of the measurement result and the analysis result of the target sample is clear. Therefore, the evaluation of the validity of the measurement result and the analysis result of the target sample can be performed more accurately and efficiently.

(Clause 4) The mass spectrometer according to any one of clauses 1 to 3 may further include:
a determination unit configured to determine quality of a measurement state based on the measurement result and the analysis result derived from the measurement result every time the measurement result for a quality control sample is acquired; and
a control unit configured to control the measurement unit to stop the measurement by the measurement unit when the determination unit determines that the measurement state is defective.

(Clause 5) In the mass spectrometer according to clause 4, the display processor may be configured to display a quality determination result of the measurement state by the determination unit together with the analysis result, and the control unit may be configured to control the measurement unit to stop measurement by the measurement unit in response to an instruction from a user.

With the mass spectrometer according to clauses 4 and 5, the measurement can be promptly stopped to avoid unnecessary measurement when there is a possibility that the measurement has not been appropriately performed due to a defect of the device, an error in preparation of the sample or setting of the measurement conditions, and the like. Accordingly, it is possible to prevent waste of time and labor for a wasteful measurement. In addition, the operator can quickly start to investigate causes of improper measurement.

(Clause 6) In the mass spectrometer according to any one of clauses 1 to 5, the display processor may include an individual result creation unit configured to extract the measurement result and/or the analysis result for one target sample to create display information in a predetermined format, and display the display information on a screen of the display unit.

With the mass spectrometer according to clause 6, the mass spectrometer can individually display the measurement result and the analysis result for each target sample. As a result, for example, when it is necessary to disclose the analysis result to the subject, only the analysis result of the subject can be disclosed. In addition, when the operator or the like wants to confirm the analysis result of a specific subject, the mass spectrometer can prevent confusion with the analysis results of other subjects.

(Clause 7) The mass spectrometer according to any one of clauses 1 to 6 may further include an analysis unit configured to detect a plurality of amyloid β-related peaks from a mass spectrum acquired by the measurement by the measurement unit and calculate an index value as the analysis result by a predetermined calculation based on signal intensity of the detected peaks.

The amyloid β-related peak detected from the mass spectrum is an amyloid β-derived peptide having a specific mass-to-charge ratio used in a known inspection method disclosed in Patent Literatures 2 to 3, Non Patent Literature 1, and the like, for example, Aβ1-39, Aβ1-40, Aβ1-42, APP669-711, and the like.

According to the mass spectrometer according to clause 7, the accuracy and efficiency of a screening test for examining the state of accumulation of the amyloid β in the brain can be improved.

### REFERENCE SIGNS LIST

1... Measurement Unit
10... MALDI Ion Source
100... Stage
101... Sample Plate
102... Sample
103... Laser Irradiation Unit
11... Time-of-Flight Mass Spectrometry Unit
2... Control/Processing Unit
20... Sample Information Storage Unit
21... Analysis Control Unit
22... Mass Spectrum Data Collector
23... Data Analysis Unit
24... Quality Determination Unit
25... Display Processor
251... Analysis Result List Creation Unit
252... Individual Analysis Result Report Creation Unit
3... Input Unit
4... Display Unit

1. A mass spectrometer comprising:
a measurement unit configured to perform mass spectrometry on each of a plurality of target samples and a plurality of quality control samples in a predetermined order;
a sample information storage unit which stores discrimination information capable of discriminating between the target sample and the quality control sample in a series of measurements of the target samples and the quality control samples; and
a display processor configured to separate a measurement result for the target sample and/or an analysis result derived from the measurement result, and a measurement result for the quality control sample and/or an analysis result derived from the measurement result to create display information in a predetermined format respectively, and display the two pieces of display information on a screen of a display unit by using the discrimination information stored in the sample information storage unit.

2. The mass spectrometer according to claim 1, wherein the measurement unit is configured to perform matrix-assisted laser desorption/ionization mass spectrometry.

3. The mass spectrometer according to claim 1, wherein the display information includes information indicating a relationship between a quality control sample and a target sample for which quality of the measurement result and the analysis result is evaluated using the sample.

4. The mass spectrometer according to claim 1 further comprising:
a determination unit configured to determine quality of a measurement state based on the measurement result and the analysis result derived from the measurement result every time the measurement result for a quality control sample is acquired; and
a control unit configured to control the measurement unit to stop the measurement by the measurement unit when the determination unit determines that the measurement state is defective.

5. The mass spectrometer according to claim 4, wherein the display processor is configured to display a quality determination result of the measurement state by the determination unit together with the analysis result, and the control unit is configured to control the measurement unit to stop measurement by the measurement unit in response to an instruction from a user.

6. The mass spectrometer according to claim 1, wherein the display processor includes an individual result creation unit configured to extract the measurement result and/or the analysis result for one target sample to create display information in a predetermined format, and display the display information on a screen of the display unit.

7. The mass spectrometer according to claim 1 further comprising an analysis unit configured to detect a plurality of amyloid β-related peaks from a mass spectrum acquired by the measurement by the measurement unit and calculate an index value as the analysis result by a predetermined calculation based on signal intensity of the detected peaks.
